(19) United States
(12) Patent Application Publication
(10) Pub. No.: US 2014/0034138 A1
(43) Pub. Date: Feb. 6, 2014

(54) SEMICONDUCTOR MANUFACTURING DEVICE AND MANUFACTURING METHOD THEREOF

(71) Applicants: Ki-Hoon Lee, Yongin-si (KR); Dong-Ho Ryu, Hwaseong-si (KR)

(72) Inventors: Ki-Hoon Lee, Yongin-si (KR); Dong-Ho Ryu, Hwaseong-si (KR)

(73) Assignee: WONIK IPS CO., LTD., Pyeongtaek-si (KR)

(21) Appl. No.: 14/111,865

(22) PCT Filed: Apr. 12, 2012
(86) PCT No.: PCT/KR2012/002741

§ 371 Date: Oct. 15, 2013

(30) Foreign Application Priority Data
Apr. 15, 2011 (KR) 10-2011-0035291

(51) Int. Cl. F17D 1/04

(52) U.S. Cl. CPC F17D 1/04
USPC 137/1; 137/356

(57) ABSTRACT

The present invention relates to a semiconductor manufacturing device, which can be applied in a semiconductor metal interconnection process, and a manufacturing method thereof. The semiconductor manufacturing device includes a loadlock chamber, at least one process chamber, a transfer chamber, and an oxidation preventing gas supply unit. The process chamber processes an annealing process by receiving a substrate. The transfer chamber transfers the substrate between the loadlock chamber and the process chamber. The oxidation preventing gas supply unit supplies oxidation preventing gas into either the transfer chamber or the loadlock chamber.

### TECHNICAL FIELD

The following description relates to a semiconductor manufacturing device and method, and more particularly, to a semiconductor manufacturing device and method applicable to a semiconductor metal wiring process.

### BACKGROUND ART

Generally, aluminum, featuring in low cost and favorable properties, has been widely used for a semiconductor metal wiring process. Recently, however, the use of copper has been increasing to obtain a faster signal transmission speed of a semiconductor device. Copper has lower resistance properties and greater electromigration resistance than aluminum.

A copper wiring process includes operations of: sequentially stacking a conductive layer and an insulating layer on a substrate, such as a wafer; and forming a contact hole passing through the insulating layer. Copper is inserted into the contact hole, and then the planarization is performed on the inserted copper surface by use of chemical mechanical polishing. Thereafter, the subsequent processes are executed. In this case, a contact portion of copper may swell upward due to the thermal expansion and crystalline changes of copper caused by the thermal budget of the subsequent process. This may lead to defective contacts, resulting in, for example, cracks in the semiconductor device.

To overcome the above drawbacks, an annealing process is performed after the CMP process on copper, thereby increasing a volume of copper, and then the CMP process is carried on. Copper tends to be oxidized even in a very small amount of moisture or oxygen. Further, the oxidation of copper is increased at a higher temperature. The oxidized copper leads to an increase in contact resistance, which results in a number of problems, such as an increase in power consumption and a decrease in signal transmission speed of the semiconductor device.

### DETAILED DESCRIPTION OF THE INVENTION

Technical Objective

The technical objective of the present invention is to provide a semiconductor manufacturing device and manufacturing method capable of preventing the oxidation of a metal layer or the like of a substrate during an annealing process on the substrate.

Technical Solution

According to an exemplary embodiment of the present invention, a semiconductor manufacturing device may include: a loadlock chamber; one or more process chamber configured to receive a substrate and perform an annealing process; a transfer chamber configured to transfer the substrate between the loadlock chamber and the process chamber; and an oxidation preventing gas supplying unit configured to supply an oxidation preventing gas to at least one of the transfer chamber and the loadlock chamber.

According to another exemplary embodiment of the present invention, a semiconductor manufacturing method may include: transferring a substrate into a process chamber from a loadlock chamber using a transfer chamber while supplying an oxidation preventing gas to at least one of the transfer chamber and the loadlock chamber; performing an annealing process on the substrate transferred in the process chamber; and transferring the substrate, on which the annealing process is performed, from the process chamber to the transfer chamber while supplying an oxidation preventing gas to at least one of the transfer chamber and the loadlock chamber.

### Advantageous Effects

According to the present invention, a substrate is transferred into or out of a process chamber in which an annealing process is performed on the substrate, while an oxidation preventing gas is being supplied to at least one of a transfer chamber and a loadlock chamber, so that it is possible to prevent the oxidation of a metal layer or the like of the substrate. Therefore, the contact resistance of the metal layer does not increase, and thereby it may be possible to prevent the occurrence of problems, such as an increase in power consumption and a decrease in signal transmission speed of a semiconductor device.

### DESCRIPTION OF DRAWINGS

FIG. 1 is a configuration diagram illustrating a semiconductor manufacturing device, according to a first exemplary embodiment of the present invention.

FIG. 2 is a configuration diagram illustrating a semiconductor manufacturing device, according to a second exemplary embodiment of the present invention.

FIG. 3 is a configuration diagram illustrating a semiconductor manufacturing device, according to a third exemplary embodiment of the present invention.

FIG. 4 is a configuration diagram illustrating a semiconductor manufacturing device, according to a fourth exemplary embodiment of the present invention.

FIG. 5 is a configuration diagram illustrating a semiconductor manufacturing device, according to a fifth exemplary embodiment of the present invention.

FIG. 6 is a configuration diagram illustrating the semiconductor manufacturing device of FIG. 4 with a cooling module.

FIG. 7 is a side cross-sectional view of a process chamber of FIG. 1.

### MODE FOR INVENTION

Hereinafter, exemplary embodiments of the present invention will be described with reference to accompanying drawings.

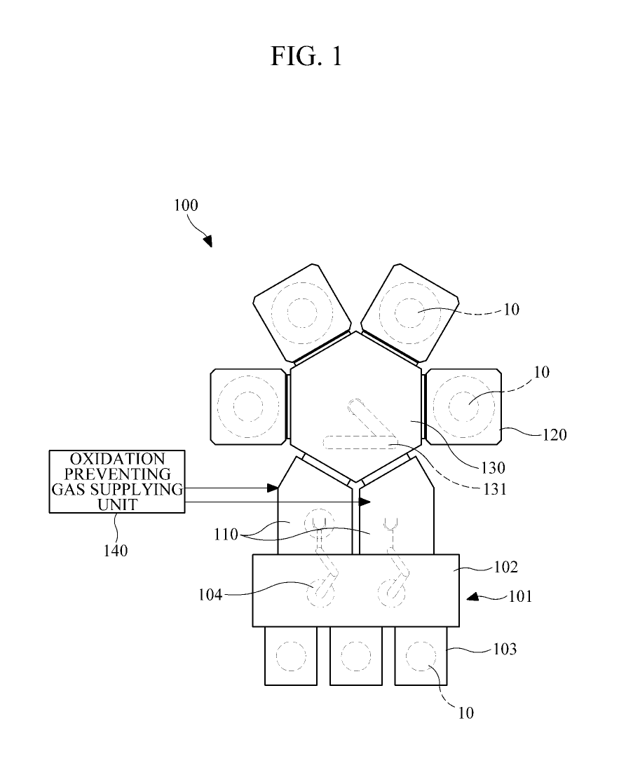

FIG. 1 is a configuration diagram illustrating a semiconductor manufacturing device, according to a first exemplary embodiment of the present invention. Referring to FIG. 1, the semiconductor manufacturing device 100 includes a loadlock chamber 110, at least one process chamber 120, a transfer chamber 130, and an oxidation preventing gas supply unit 140.

Before a substrate 10, such as a wafer, is transferred into the process chamber 120 from the outside of the device under an atmospheric pressure, the loadlock chamber 110 accommodates the substrate 10 under the substantially same condition as the vacuum environment in the process chamber 120, or accommodates the substrate 10 under the substantially same condition as an atmospheric pressure before the substrate 10 is removed from the transfer chamber 130 to the outside of the device.

For example, a substrate handling module 101 may be provided at the exterior of the loadlock chamber 110. The substrate handling module 101 includes a frame 102 and a substrate storage container 103 located at one side of the frame 102. Inside the frame, an atmospheric robot 104 is installed to convey the substrate 10 between the substrate storage container 103 and the loadlock chamber 110. The process chamber 120 receives the substrate 10 and performs an annealing process on the substrate 10. In this case, the substrate 10 to be supplied to the process chamber 120 may have a metal layer formed thereon. The metal layer may be formed by inserting metal in the substrate 10. For example, after a conductive layer and an insulating layer are sequentially stacked on each other, a contact hole is formed to penetrate the insulating layer. Metal is injected into the contact hole, and then a resulting metal surface is planarized using chemical mechanical polishing (CMP). By this process, the substrate 10 with metal injected therein can be provided to the process chamber 120. The injected metal may be copper Cu.

There may be provided a plurality of process chambers 120 disposed around the transfer chamber 130. In addition, the loadlock chamber 110, placed between the process chambers 120, is connected to the transfer chamber 130. Accordingly, the semiconductor manufacturing device 100 can be implemented as a cluster system. Each process chamber 120 may be configured to perform an annealing process. In another example, at least one of the process chambers 120 may perform an annealing process, and the other process chambers 120 may perform a CMP process.

The transfer chamber 130 transfers the substrate 10 between the loadlock chamber 110 and the process chamber 120. The transfer chamber 130 conveys the substrate 10 from the loadlock chamber 110 to the process chamber 120, or discharges the substrate 10 from the process chamber 120 to the loadlock chamber 110. The transfer chamber 130 with vacuum inside has the vacuum robot 131 installed therein to transfer the substrate 10.

The oxidation preventing gas supplying unit 140 supplies an oxidation preventing gas to the loadlock chamber 110. While the substrate 10 is located in the loadlock chamber 110, the oxidation preventing gas supplying unit 140 supplies the loadlock chamber 110 with the oxidation preventing gas in an effort to prevent the oxidation of a metal layer or the like of the substrate 10.

For example, for a copper metal layer, the oxidation preventing gas may be hydrogen (H₂) gas or a gas containing hydrogen. The hydrogen gas reacts with oxygen or moisture in the air inside the loadlock chamber 110, thereby preventing oxidation of the copper, which is caused by reaction with the oxygen or moisture. That is, the hydrogen gas serves as a reducing agent. By preventing the oxidation of copper, an increase in contact resistance is prevented, and it is thus possible to also prevent an increase in power consumption and a decrease in signal transmission speed of a semiconductor device.

The oxidation preventing gas supplying unit 140 may supply the oxidation preventing gas to the loadlock chamber 110 when the substrate 10 is transferred into the process chamber 120.

The process chamber 120 for performing an annealing process is at a high temperature. The oxidation of the metal layer or the like of the substrate 10 may be prevented by the oxidation preventing gas even when the substrate 10 is exposed to the high temperature of the process chamber 120 before entering the process chamber 120, because the process chamber 120 has its slot valve opened to allow the substrate 10 to enter while the oxidation preventing gas is being supplied to the loadlock chamber 110.

In addition, the oxidation preventing gas supplying unit 140 may supply the oxidation preventing gas to the loadlock chamber 110 when the substrate 10 is removed from the process chamber 120. The oxidation of the metal or the like of the substrate 10 may be prevented by the oxidation preventing gas even when the substrate 10 is exposed to the high temperature of the process chamber 120 after being removed from the process chamber 120, because the process chamber 120 has its slot valve opened to discharge the substrate 10 while the oxidation preventing gas is being supplied to the loadlock chamber 110.

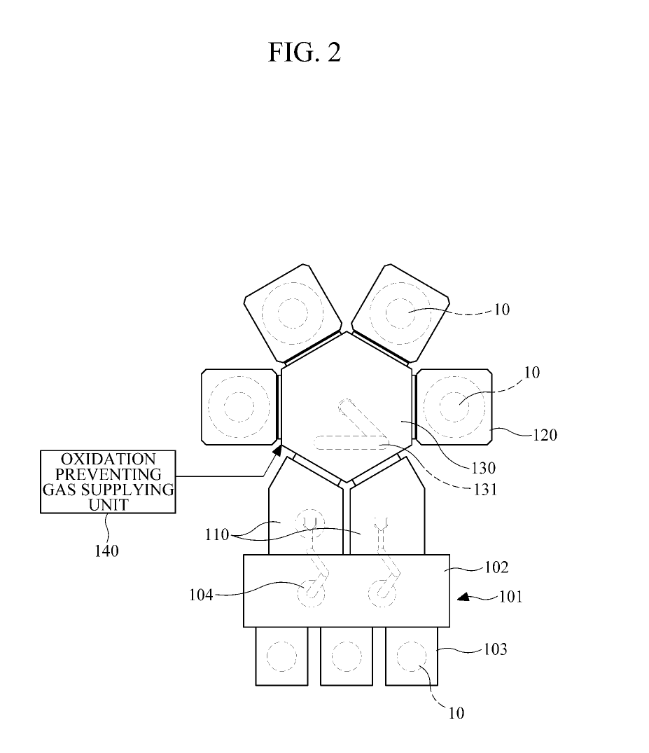

In another example, as shown in FIG. 2, the oxidation preventing gas supplying unit 140 may supply the oxidation preventing gas to the transfer chamber 130. The oxidation preventing gas supplying unit 140 supplies the oxidation preventing gas to the transfer chamber 130 to prevent the oxidation of the metal layer of the substrate 10 when the substrate 10 is placed in the transfer chamber 130, when the substrate 10 is transferred into the process chamber 120 or when the substrate 10 is removed from the process chamber 120.

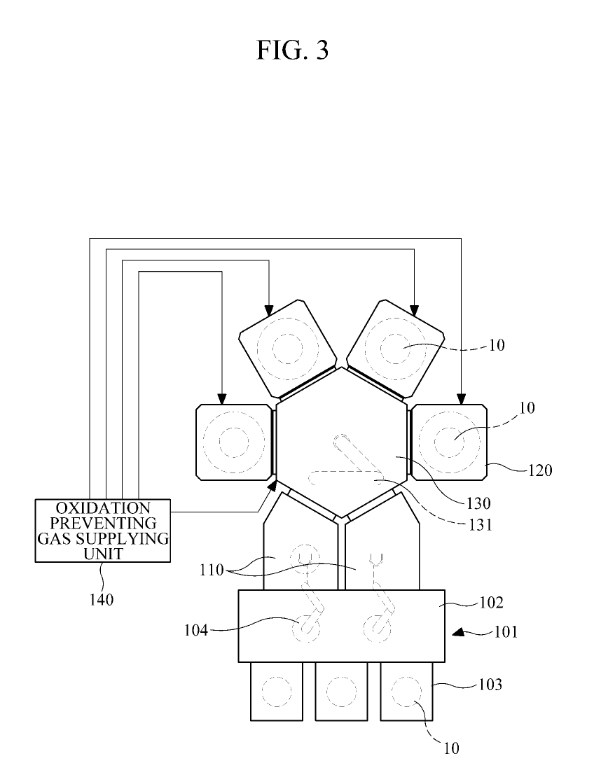

In another example, as shown in FIG. 3, the oxidation preventing gas supplying unit 140 may supply the oxidation preventing gas to the process chamber 120, as well as to the transfer chamber 130. In this case, when the substrate 10 is carried into the process chamber 120 or when the substrate 10 is removed from the process chamber 120, the oxidation preventing gas supplying unit 140 may supply the oxidation preventing gas to both the transfer chamber 130 and the process chamber 120 simultaneously.

As a result, it is possible to improve the efficiency in preventing the oxidation of the metal layer of the substrate 10 when the substrate 10 is transferred into the process chamber 120 or when the substrate 10 is removed from the process chamber 120. In addition, when the process chamber 120 performs an annealing process on the substrate 10, the oxidation preventing gas supplying unit 140 may supply the oxidation preventing gas to the process chamber 120. Accordingly, it is possible to improve the efficiency in preventing the oxidation of the metal layer of the substrate 10 during the annealing process.

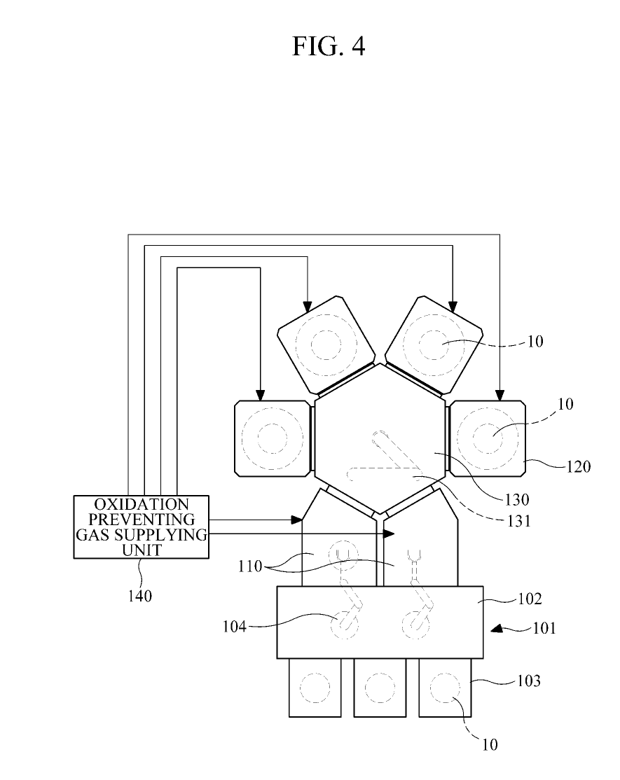

In another example, as shown in FIG. 4, the oxidation preventing gas supplying unit 140 may be configured to supply the oxidation preventing gas to the loadlock chamber 110 and the process chamber 120. In this case, when the substrate 10 is transferred into the process chamber 120 or when the substrate 10 is removed from the process chamber 120, the oxidation preventing gas supplying unit 140 may supply the oxidation preventing gas to both the loadlock chamber 110 and the process chamber 120 simultaneously.

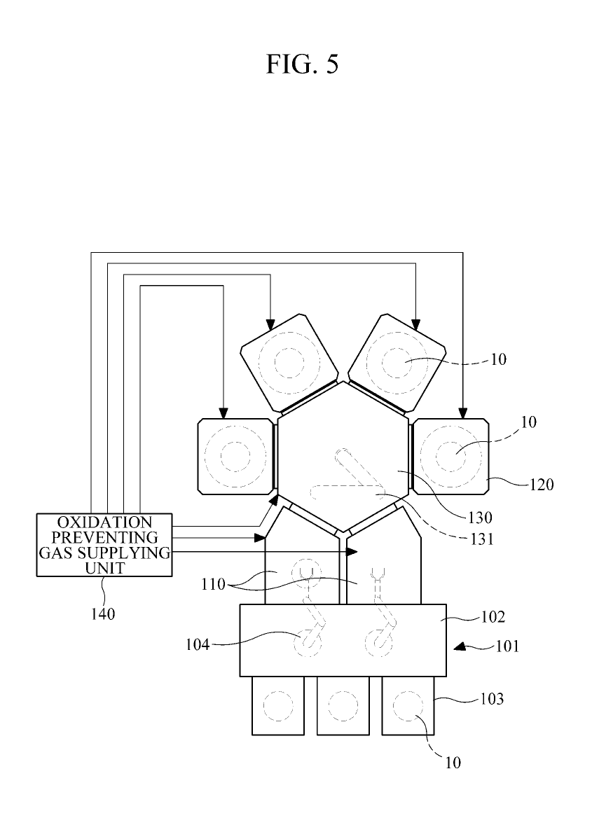

As shown in FIG. 5, the oxidation preventing gas supplying unit 140 may supply the oxidation preventing gas to all the loadlock chamber 110, the process chamber 120, and the transfer chamber 130.

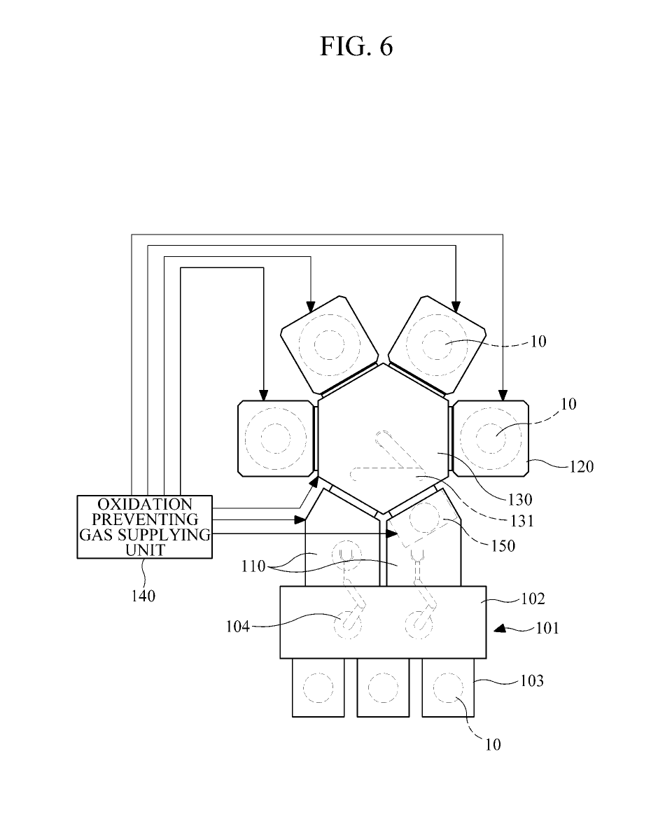

As shown in FIG. 6, the substrate 10 removed from the process chamber 120 may be cooled by a cooling module 150. The cooling module 150 may be disposed on the transfer chamber 130 to cool the substrate 10 after the annealing process. While the cooling module 150 is cooling the substrate 10, the oxidation preventing gas supplying unit 140 may supply an oxidation preventing gas to the cooling module 150 to prevent the oxidation of the metal layer of the substrate 10 and also to contribute to cooling of the substrate 10 to a temperature below 100 C. The cooling module 150 is supplied with the oxidation preventing gas directly from the oxidation preventing gas supplying unit 140 or indirectly from the loadlock chamber 110 or the transfer chamber 130 to which the oxidation preventing gas has been supplied. The cooling module 150 may be disposed in the loadlock chamber 110 or disposed in both the transfer chamber 130 and the loadlock chamber 110.

When the substrate 10 is carried into the process chamber 120 or removed from the process chamber 120, the transfer chamber 130 may have the same or higher pressure than a pressure within the process chamber 120. Hence, particles or other substances are prevented from getting into the transfer chamber 130 from the process chamber 120, thereby minimizing particle contamination of the substrate 10 before entering and after leaving the process chamber 120.

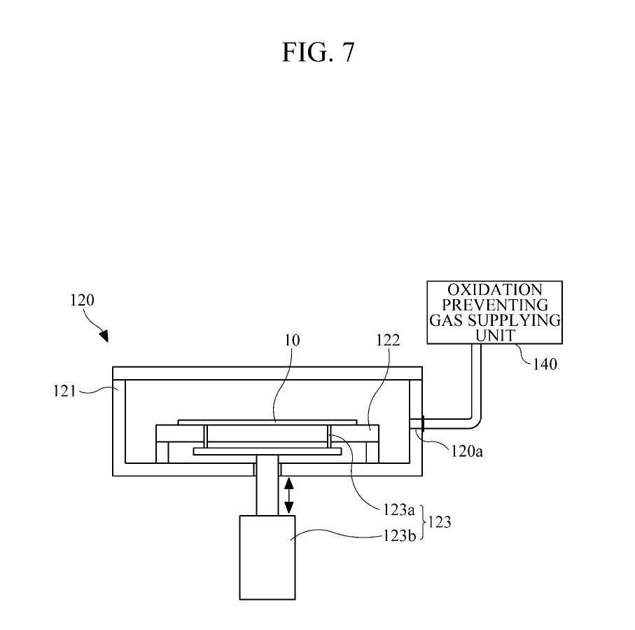

As shown in FIG. 7, the process chamber 120 may include a susceptor 122 and a substrate elevating unit 123. An oxidation preventing gas inlet 12a may be formed on one side of the process chamber 120, allowing the oxidation preventing gas to enter therethrough from the oxidation preventing gas supplying unit 140. The oxidation preventing gas inlet 120a is connected to the oxidation preventing gas supplying unit 140 via a supplying pipe, so that it can be supplied with the oxidation preventing gas from the oxidation preventing gas supplying unit 140. Although the oxidation preventing gas inlet 12a is illustrated as being formed on the side of the process chamber 120, the location of the oxidation prevention gas inlet 12a may vary, such as on an upper surface or a lower surface of the process chamber 120.

The susceptor 122 supports the substrate 10 situated thereon within the process chamber 121. The susceptor 122 is equipped with a heater to heat the substrate 10.

The substrate elevating unit 123 may separate the substrate 10 from the susceptor 122 or locate the substrate on the susceptor 122. For example, the substrate elevating unit 123 may receive and situate the substrate 10 on the susceptor 122 when the substrate 10 is transferred into the process chamber 121 by the transfer robot 131. In addition, the substrate elevating unit 123 separates the situated substrate 10 from the susceptor 122, thereby enabling the transfer robot 131 to carry the substrate 10 out of the process chamber 121. The substrate elevating unit 123 may include elevation pins 123a that elevates or lowers the substrate 10 while moving up and down, and an elevation actuator 123b that moves the elevation pins 123a up and down.

After the annealing process on the substrate 10 in the process chamber 120, the substrate elevating unit 123 may separate the substrate 10 from the susceptor 122. The substrate 10 which is separated from the heater of the susceptor 122 is primarily cooled, and then removed from the process chamber 120. Thus, when the substrate 10 is removed from process chamber 120, it is possible to improve the efficiency in preventing the oxidation of a metal layer of the substrate 10.

A semiconductor manufacturing method in accordance with an exemplary embodiment of the present invention will be described hereinafter. First, while an oxidation preventing gas is supplied to at least one of the transfer chamber 130 and the loadlock chamber 110, the transfer chamber 130 transfers the substrate 10 from the loadlock chamber 110 to the process chamber 120. At this time, a metal layer is formed on the substrate 10 by inserting copper into the substrate 10. In this case, the oxidation preventing gas may be hydrogen gas or a gas containing hydrogen gas. With the hydrogen gas being supplied to the transfer chamber 130 and/or the loadlock chamber 110, the substrate 10 is transferred into the process chamber 10, so that it is possible to prevent the copper oxidation.

In the course of transferring the substrate 10 into the process chamber 120, the oxidation preventing gas can be supplied to at least one of the transfer chamber 130 and the loadlock chamber 110, and at the same time to the process chamber 120 simultaneously. By doing so, it may be possible to improve efficiency of copper oxidation prevention. Further, in the course of transferring the substrate 10 into the process chamber 120, a pressure within the transfer chamber 130 may be set to be the same as or greater than a pressure within the process chamber 120. Accordingly, particles or other substances are prevented from getting into the transfer chamber 130 from the process chamber 120, so that it is possible to minimize the particle contamination of the substrate 10 before being transferred into the process chamber 120.

Thereafter, an annealing process is performed on the substrate 10 in the process chamber 120. During the annealing process, the oxidation preventing gas may be supplied into the process chamber 120. Hence, it may be possible to improve the efficiency of copper oxidation prevention of the substrate 10. After completing the annealing process of the substrate 10, the substrate may be separated from the susceptor 122. The substrate 10 which is separated from the heater of the susceptor 122 is primarily cooled, and then transferred out of the process chamber 120, so that it may be possible to improve the efficiency of copper oxidation prevention when removing the substrate from the process chamber.

After completing the annealing process on the substrate 10, the processed substrate 10 is conveyed from the process chamber 120 to the transfer chamber 130 while the oxidation preventing gas is supplied to at least one of the transfer chamber 130 and the loadlock chamber 110. The oxidation preventing gas may be supplied to at least one of the transfer chamber 130 and the loadlock chamber 110, and at the same time to the process chamber 120, in the course of transferring the substrate 10 to the transfer chamber 130. As a result, the efficiency of copper oxidation prevention can be increased.

Moreover, when the substrate 10 is removed from the process chamber 120, a pressure within the transfer chamber 130 may be set to be the same as or greater than a pressure within the process chamber 120. Thus, it is possible to prevent particles or other substances from getting into the transfer chamber 130 from the process chamber 130, thereby minimizing the particle contamination of the substrate 10 after being transferred out of the process chamber. Further, in the course of removing the substrate 10 from the process chamber 120, the substrate 10 is cooled by the cooling module 150 that is disposed in the transfer chamber 130 and/or the loadlock chamber 110, and the oxidation preventing gas is provided to the cooling module 150, thereby preventing the copper oxidation.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A semiconductor manufacturing device, comprising:
a loadlock chamber;
one or more process chambers each configured to receive a substrate and perform an annealing process;
a transfer chamber configured to transfer the substrate between the loadlock chamber and the process chamber; and
an oxidation preventing gas supplying unit configured to supply an oxidation preventing gas to at least one of the transfer chamber and the loadlock chamber.

2. The semiconductor manufacturing device of claim 1, wherein the oxidation preventing gas supplying unit supplies the oxidation preventing gas to at least one of the transfer chamber and the loadlock chamber when the substrate is transferred into the process chamber or when the substrate is transferred out of the process chamber.

3. The semiconductor manufacturing device of claim 1, wherein the oxidation preventing gas supplying unit is configured to supply the oxidation preventing gas to the process chamber.

4. The semiconductor manufacturing device of claim 3, wherein the oxidation preventing gas supplying unit supplies the oxidation preventing gas to at least one of the transfer chamber and the loadlock chamber and at the same time to the process chamber when the substrate is transferred into the process chamber or when the substrate is transferred out of the process chamber.

5. The semiconductor manufacturing device of claim 4, wherein the transfer chamber has an inner pressure that is set to be a same as or greater than an inner pressure of the process chamber when the substrate is transferred into the process chamber or when the substrate is transferred out of the process chamber.

6. The semiconductor manufacturing device of claim 3, wherein the oxidation preventing gas supplying unit supplies the oxidation preventing gas to the process chamber while the process chamber is performing the annealing process on the substrate.

7. The semiconductor manufacturing device of claim 1, wherein the process chamber is configured to comprise a susceptor to support and heat the substrate and a substrate elevating unit configured to separate the substrate from the susceptor or situate the substrate on the susceptor, and after the annealing process is completed in the process chamber, the substrate elevating unit separates the substrate from the susceptor.

8. The semiconductor manufacturing device of claim 7, further comprising:
a cooling module disposed between the transfer chamber and the loadlock chamber to cool the substrate on which the annealing process is performed;
wherein the oxidation preventing gas supplying unit supplies an oxidation preventing gas to the cooling module when the cooling module cools the processed substrate.

9. The semiconductor manufacturing device of one of claim 1, wherein the substrate comprises a metal layer formed therein, and the metal layer is made of copper.

10. The semiconductor manufacturing device of claim 9, wherein the oxidation preventing gas is hydrogen (H₂) gas or a gas containing hydrogen.

11. A semiconductor manufacturing method comprising:
transferring a substrate into a process chamber from a loadlock chamber using a transfer chamber while supplying an oxidation preventing gas to at least one of the transfer chamber and the loadlock chamber;
performing an annealing process on the substrate transferred in the process chamber; and
transferring the substrate, on which the annealing process is performed, from the process chamber to the transfer chamber while supplying an oxidation preventing gas to at least one of the transfer chamber and the loadlock chamber.

12. The semiconductor manufacturing method of claim 11, wherein the performing of the annealing process on the substrate comprises supplying the oxidation preventing gas to the process chamber.

13. The semiconductor manufacturing method of claim 11, wherein in the transferring of the substrate into the process chamber or out of the process chamber, the oxidation preventing gas is supplied to at least one of the transfer chamber and the loadlock chamber, and at the same time to the process chamber.

14. The semiconductor manufacturing method of claim 11, wherein in the transferring of the substrate into the process chamber or out of the process chamber, a pressure within the transfer chamber is set to be a same as or greater than a pressure within the process chamber.

15. The semiconductor manufacturing method of claim 11, wherein after the annealing process is completed on the substrate, the substrate is separated from a susceptor on which the substrate has been situated.

16. The semiconductor manufacturing method of claim 15, wherein the transferring of the substrate out of the process chamber comprises cooling the substrate using a cooling module disposed between the transfer chamber and the loadlock chamber, wherein the oxidation preventing gas is supplied to the cooling module when the cooling module cools the substrate.

17. The semiconductor manufacturing method of one of claim 11, wherein the substrate comprises a metal layer formed therein, and the metal layer is made of copper.

18. The semiconductor manufacturing method of claim 17, wherein the oxidation preventing gas is hydrogen (H₂) gas or a gas containing hydrogen.
